(19) United States
(12) Patent Application Publication
(10) Pub. No.: US 2018/0143653 A1
(43) Pub. Date: May 24, 2018

(54) FLOW CONTROL DEVICE AND MIXING SYSTEM COMPRISING SUCH A DEVICE

(71) Applicant: EXEL INDUSTRIES, Epernay (FR)

(72) Inventors: Maxime SPICA, St Trivier-Sur-Moignans (FR); Sébastien BARON, Trevoux (FR)

(73) Assignee: EXEL INDUSTRIES, Epernay (FR)

(21) Appl. No.: 15/574,995

(22) PCT Filed: May 19, 2016
(86) PCT No.: PCT/EP2016/061199

§ 371 Date: Nov. 17, 2017

(30) Foreign Application Priority Data
May 19, 2015 (FR) 1554456

(51) Int. Cl. G05D 11/00

(52) U.S. Cl. CPC G05D 11/006

(57) ABSTRACT

This flow control device (60) for a liquid in a pipe comprises a hollow body (62) including an inlet port (620) and an outlet port (622) between which a liquid is able to flow. It includes at least one adjustment element able to rotate in the hollow body (62), the adjustment element comprising several rotating discs rotatably secured to one another and each pierced with several orifices having different diameters. The device (60) comprises stationary intermediate discs relative to the adjustment element and inserted between the rotating discs, the intermediate discs being pierced with at least one orifice. The adjustment element is suitable for being rotated so as to be able to place one of the orifices of the rotating discs across from the orifice of the intermediate disc.

The present invention relates to a device for controlling the flow of a liquid, and a system for mixing a chemical product with water comprising such a regulating device.

The devices for regulating the flow of a liquid known in the state of the art do not make it possible to obtain low liquid flow rates able to be adjusted very precisely, in particular for spraying phytosanitary products mixed with water at very precise concentrations.

The invention more particularly aims to resolve these drawbacks by proposing a new device for controlling the flow of a liquid, making it possible to adjust small flows of liquid with high precision.

To that end, the invention relates to a flow control device for a liquid in a pipe, comprising a hollow body including an inlet port and an outlet port between which a liquid is able to flow. It includes at least one adjustment element able to rotate in the hollow body, the adjustment element comprising several rotating discs rotatably secured to one another and each pierced with several orifices having different diameters. The device comprises stationary intermediate discs relative to the adjustment element and inserted between the rotating discs, the intermediate discs being pierced with at least one orifice. The adjustment element is suitable for being rotated so as to be able to place one of the orifices of the rotating discs across from the orifice of the intermediate disc.

Owing to the invention, the flow of liquid can be adjusted very finely owing to the passage of the liquid in multiple orifices, which make it possible to obtain low flows able to be adjusted precisely.

According to advantageous, but optional aspects of the invention, such a device may incorporate one or more of the following features, considered in any technically allowable combination:
The respective orifices of two adjacent intermediate discs and the respective orifices of two adjacent rotating discs are angularly offset relative to a central axis of the device, preferably by an angle of 180°.
Each intermediate disc comprises two orifices that are diametrically opposite relative to a central axis of the device.
The adjustment element comprises a dial, suitable for being manipulated by a user to adjust the position of the adjustment element, and provided with positioning reference marks suitable for being viewed through an opening of the hollow body.
The intermediate discs are mounted stationary in a tube mounted stationary in the hollow body, and in that the rotating discs are mounted rotatably in the tube.
The adjustment element comprises three rotating discs.
The device comprises three adjustment elements able to be adjusted independently.
Each rotating disc comprises four orifices with increasing diameters.
The rotating discs are secured in rotation with one another by complementary protruding shapes that extend through holes arranged in the intermediate discs.

The invention also relates to a system for mixing a chemical product with water, characterized in that it comprises a control device as described above, suitable for controlling the quantity of water mixed with the chemical product.

The invention will be better understood, and other advantages thereof will appear more clearly, in light of the following description of a control device and a mixing system according to its principle, provided as a non-limiting example in reference to the appended drawings, in which:

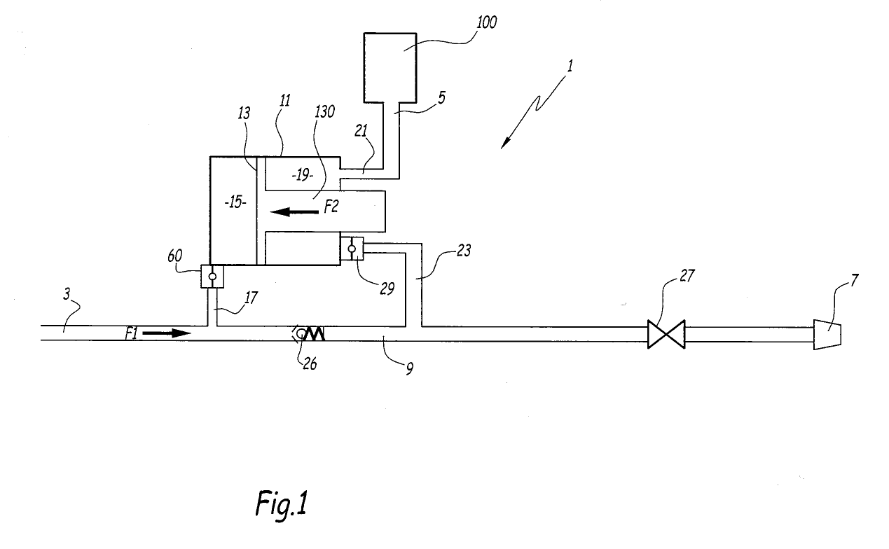

FIG. 1 is a schematic view of a mixing system according to a first embodiment of the invention;

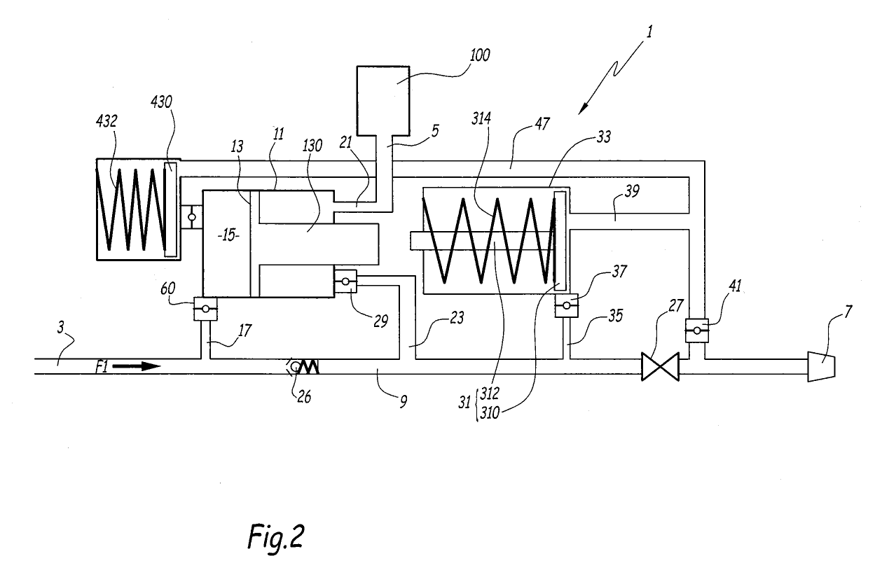

FIGS. 2 to 7 are schematic views of a mixing system according to a second embodiment of the invention, in several usage configurations;

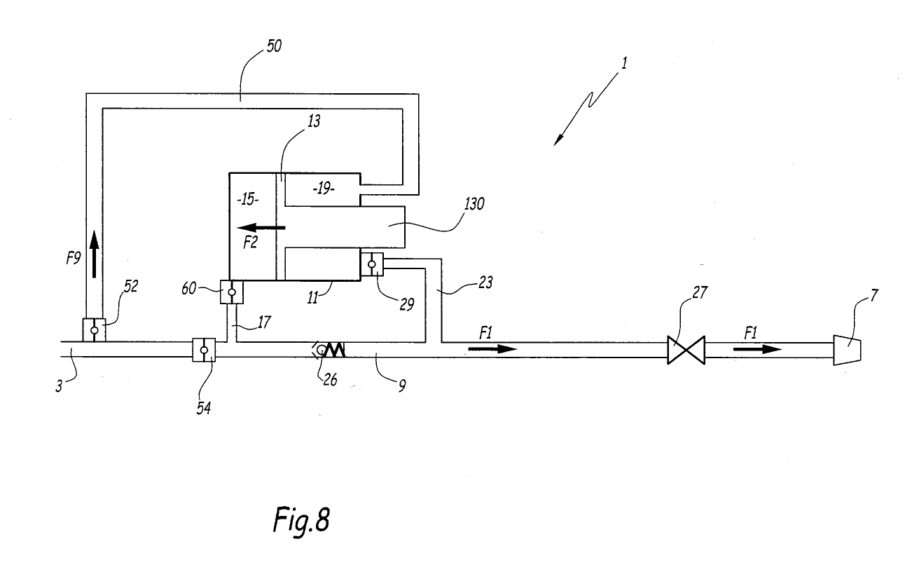

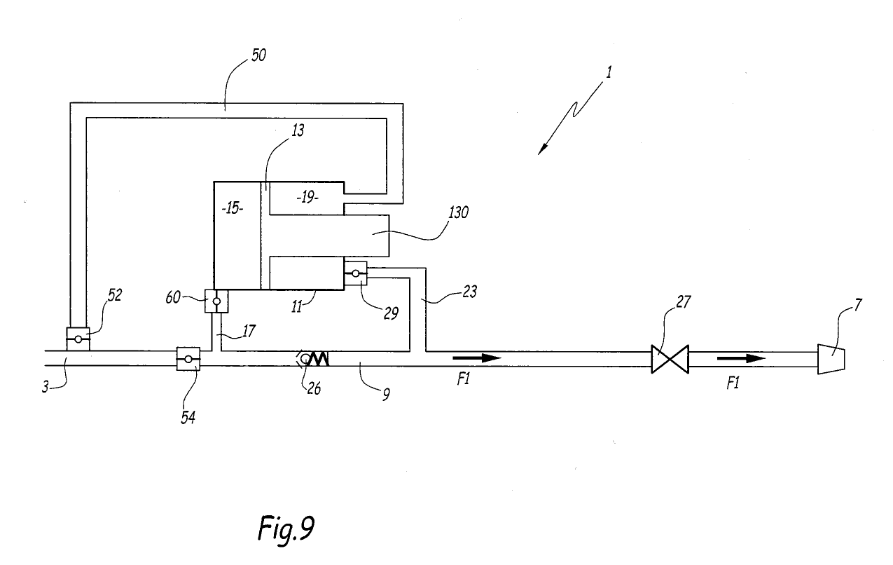

FIGS. 8 and 9 are schematic views of a mixing system according to a third embodiment of the invention, in two usage configurations;

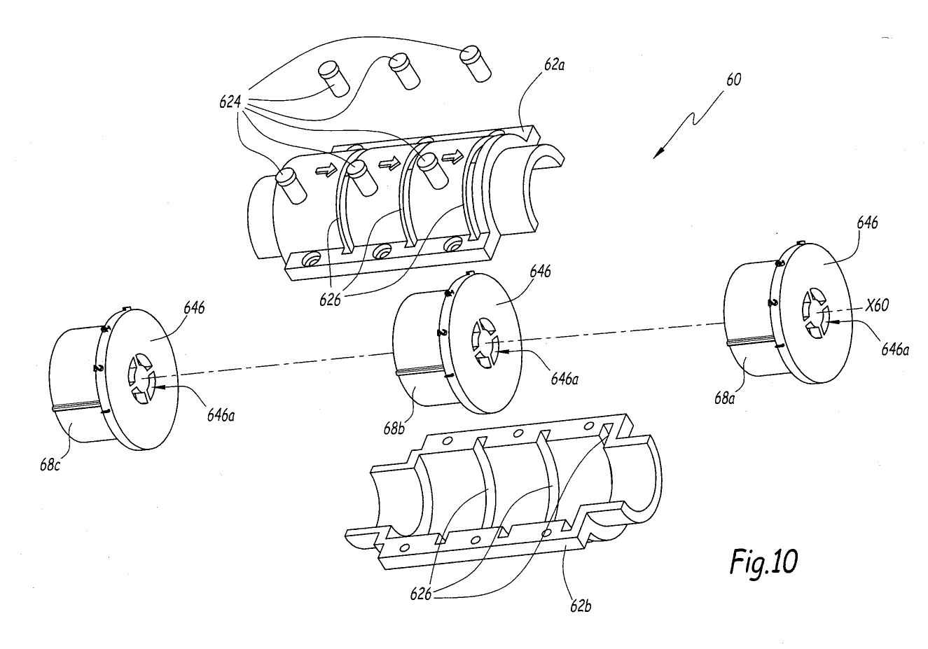

FIG. 10 is an exploded perspective view of a flow control device according to the invention belonging to the mixing systems of FIGS. 1 to 9;

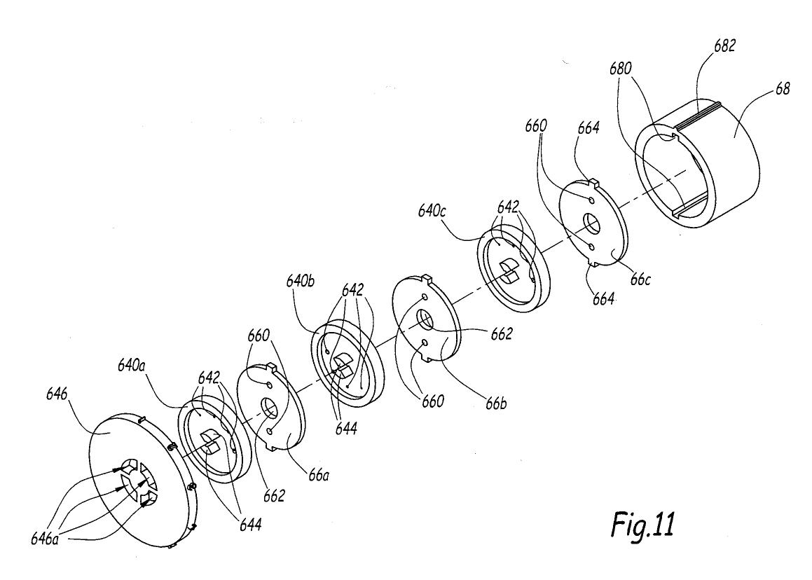

FIG. 11 is an exploded perspective view of part of the device of FIGS. 10 and 11;

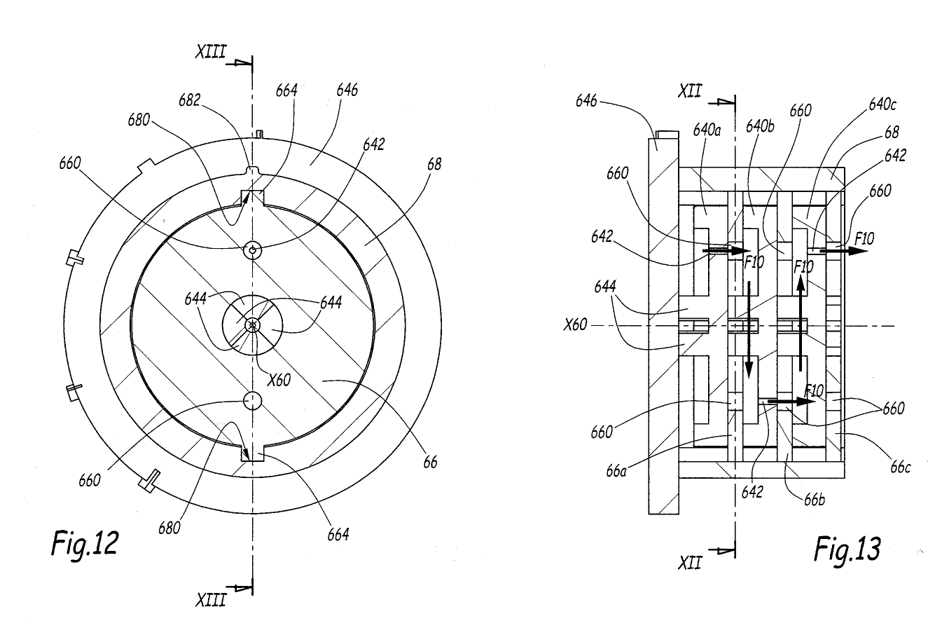

FIG. 12 is a cross-sectional view along plane XII-XII of the flow control part of FIG. 11;

FIG. 13 is a longitudinal sectional view along plane XIII-XIII of the control part of FIGS. 11 and 12, plane XII-XII being shown in this figure;

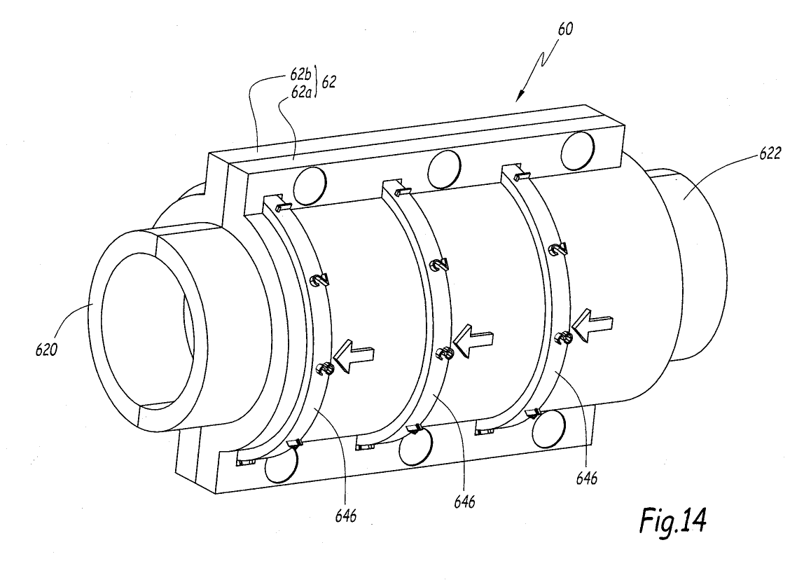

FIG. 14 is a perspective view of the flow regulator of FIG. 10.

FIG. 1 shows a mixing system 1 for mixing a chemical product, for example a phytosanitary product, with water. The system 1 comprises a water inlet port 3 suitable for being connected to a pressurized water intake pipe, for example a spraying hose. The system 1 also comprises a chemical product inlet port 5, suitable for being connected to a chemical product tank. The system 1 lastly comprises an outlet port for the mixture 7 through which the mixture formed by the water and the chemical product is for example steered toward a spraying hose or toward a product dispensing nozzle.

Between the inlet port 3 and the outlet port 7, the system 1 comprises a main pipe 9 in which the water flows along arrow F1. An upstream side of the system 1, situated on the side of the water inlet port 3, and a downstream side, situated on the side of the outlet port 7, are defined relative to the flow direction of the water in the main pipe 9.

The system 1 comprises a main chamber 11 in which a piston 13 provided with a rod 130 is able to move. The piston 13 divides the chamber 11 into two parts. A first part 15, called upstream part, situated on the left side of the piston 13 in FIG. 1, is connected to the inlet port 3 by a pipe 17. A second part 19, called downstream part, that is located to the right of the piston 13 in FIG. 1, is connected on the one hand to the product inlet port 5 by a pipe 21, and on the other hand to the main pipe 9 by a pipe 23. The downstream part 19 is therefore connected to the outlet port 7 by pipes 9 and 23.

A device 60 for controlling the flow of water in the pipe 17 is inserted between the upstream part 15 and the inlet port 3, such that the quantity of water respectively passing toward the upstream part 15 and in the main pipe 9 can be controlled. The device 60 is also suitable for cutting off the flow of water in the pipe 17. Alternatively, a valve, not shown, separate from the device 60, can be connected on the pipe 17 to activate or deactivate the flow of water in the pipe 17.

For clarity reasons, the device 60 is shown in FIGS. 1 to 9 with a valve symbol, to identify its open or closed configurations.

A nonreturn valve 26 is connected on the main pipe 9 between the pipe 17 and the pipe 23 and allows water to flow only from the inlet port 3 toward the outlet port 7. A valve 27 positioned on the main pipe 9 just before the outlet port 7 makes it possible to close off, or not close off, the mixture outlet via the outlet port 7.

When a chemical product must be mixed with a certain quantity of water using the system 1, a chemical product reservoir 100 is connected beforehand to the product inlet port 5. Next, the rod 130 is pushed into the upstream part 15 along arrow F2 in FIG. 1. To that end, the rod 130 may comprise a shape appropriate for being maneuvered manually. During the translation of the piston 13 along arrow F2, a valve 29 connected to the pipe 23 prevents the product from flowing into the pipe 23, and, by creating an underpressure during the movement of the rod 130, allows the chemical product to be suctioned in the downstream part 19.

When the desired quantity of chemical product has been injected into the downstream part 19, the mixture can be produced. Owing to a control member, not shown, the circulation of water in the main pipe 9 is activated. A flow of water predetermined by adjusting the device 25 enters the upstream part 15 via the pipe 17, while part of the water continues to flow in the pipe 9. The water entering the upstream part 15 exerts a pressure force on the piston 13. Due to the presence of the rod 130 in the downstream part 19, a pressure difference exists in the downstream part 19 relative to the upstream part 15. Indeed, the pressure force exerted by the water on the piston 13 on the side of the upstream part 15 is exerted on a larger surface than the pressure force exerted by the chemical product on the piston 13 in the downstream part 19. When a certain quantity of water is present in the upstream part 15, the force exerted by the water on the piston 13 becomes higher than the pressure force exerted by the chemical product, and the piston 13 in pushed back in the downstream part 19 in the direction opposite arrow F2. The chemical product is therefore ejected toward the pipe 23, via the valve 29, which is open, where it rejoins the water flowing in the main pipe 9. This makes it possible to perform the mixing between the water and the chemical product.

Second and third embodiments of the invention are respectively shown in FIGS. 2 to 7 and in FIGS. 8 and 9. In these embodiments, the elements shared with the first embodiment bear the same references and operate in the same manner. Only the differences with respect to the first embodiment are outlined below.

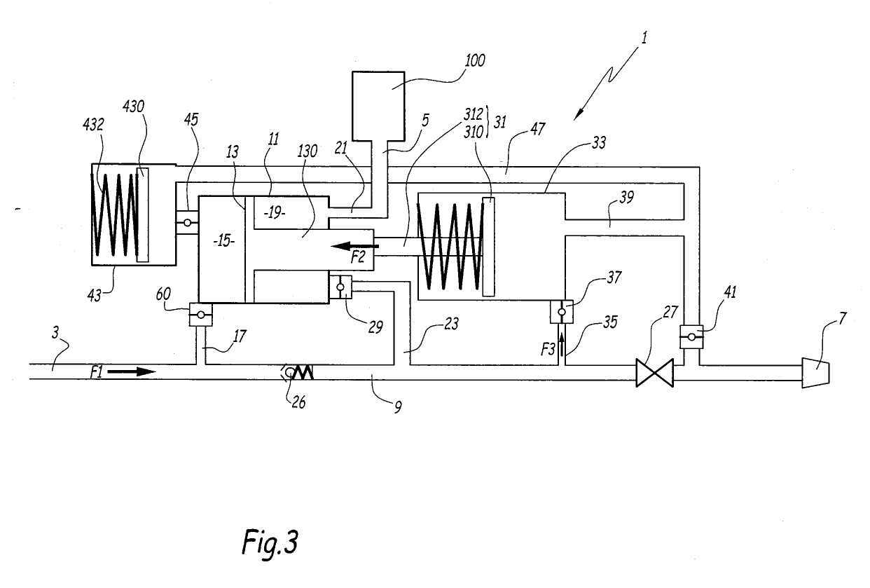

In the embodiment of FIGS. 2 to 7, the system 1 comprises a jack 31 suitable for actuating the rod 130. The jack 31 comprises a piston 310 and a rod 312. The piston 310 is mounted sliding in a chamber 33. The rod 312 protrudes outside the chamber 33 on the side of the rod 130. The piston 310 is located opposite the rod 130. The jack 31 is pushed back by a resilient element, such as a spring 314, toward a withdrawn position, shown in FIG. 2, in which the rod 312 is almost completely situated in the chamber 33. The chamber 33 is connected by a pipe 35 to the main pipe 9. A valve 37 makes it possible to allow water intake from the main pipe 9 into the chamber 33 via the pipe 35 in order to push the piston 310 back toward the piston 13, against the force of the spring 314, toward a deployed position of the jack 31, shown in FIG. 3, in which the rod 312 protrudes outside the chamber 33.

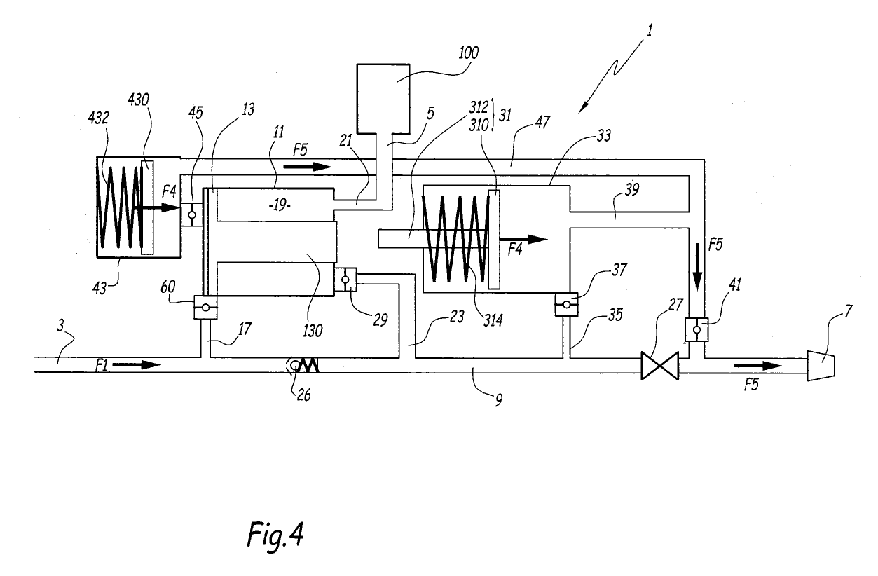

The chamber 33 can be emptied of the water that it contains by a pipe 39 that rejoins the main pipe 9 downstream from the valve 27. A valve 41 makes it possible to open or close the water passage from the pipe 39 to the main pipe 9. Thus, when the jack 31 must be pushed back into its withdrawn position shown in FIG. 2, the valve 37 is closed, which prevents the intake of water into the chamber 33. The force of the spring 314 therefore once again pushes the jack 31 back into its withdrawn position. The valve 41 is open and the water contained in the chamber 33 is driven out by the pipe 39 toward the main pipe 9, as shown in FIG. 4.

According to one optional aspect of the invention shown in FIGS. 2 to 7, the system 1 may incorporate an auxiliary chamber 43. The auxiliary chamber 43 is fluidly connected to the upstream part 15 of the main chamber 11. A valve 45 makes it possible to open or close the water passage between the upstream part 15 and the chamber 43. The auxiliary chamber 43 comprises a piston 430 that is movable between a first position, shown in FIG. 2, in which it is pushed back by a resilient element, such as a spring 432, against the end of the chamber 43 situated on the side of the valve 45, and a second position, shown in FIG. 3, in which the piston 430 is pushed back, against the force exerted by the spring 432, opposite the valve 45.

The auxiliary chamber 43 is also connected, by a pipe 47, to the main pipe 9 downstream from the valve 27. In the illustrated example, the pipe 47 joins the pipe 39. Alternatively, the pipe 47 may join the main pipe 9 independently of the pipe 39.

In the embodiment of FIGS. 2 to 7, the system 1 operates as follows. In a mixing configuration shown in FIG. 2, the regulating device 60 is configured so as to allow a certain quantity of water to pass in the upstream part 15 of the chamber 11, such that the piston 13 is pushed back toward the downstream part 19 and expels the chemical product into the pipe 23. The valve 29 is open in this configuration. The valves 45, 37 and 41 are closed in this configuration, such that the mixture of water and chemical product passing in the main pipe 9 is ejected by the outlet port 7.

Once the dispersion of the mixture is done, or the downstream part 19 has been emptied of the chemical product, the system 1 is controlled to implement a second configuration, called filling configuration, as shown in FIG. 3. In this configuration, the valve 29 is closed and the regulating device 60 is configured so as to prevent water from passing toward the upstream part 15 of the chamber 11. Simultaneously, the valves 37 and 45 are opened. The water that continues to flow in the main pipe 9 therefore fills the chamber 33 via the pipe 35, along arrows F3, and pushes the jack 31 against the force of the spring 114 in its deployed position, such that the rod 312 pushes the piston 13 in the upstream part 15, along arrow F2. This movement of the piston 13 results in driving the water contained in the upstream part 15 toward the chamber 43, and pushing back the piston 430 opposite the valve 45.

The translation toward the upstream part 15 of the piston 13 and the closing of the valve 29 result in creating an underpressure that suctions the chemical product in the downstream part 19 of the chamber 11.

When this step ends, the piston 13 is completely at the upstream end of the chamber 11, as shown in FIG. 4.

The outlet port 7 of the system 1 can next be cleaned, as shown in FIG. 4, using the water accumulated in the chambers 33 and 43. To that end, the valve 37 is closed and the valve 41 is open. As a result, the springs 314 and 432 push the pistons 310 and 430 back along arrows F4, which drive the water contained in the chambers 33 and 43 into the pipes 35 and 47, along arrows F5. This makes it possible to clean the part of the main pipe 9 situated between the valve 27 and the outlet port 7.

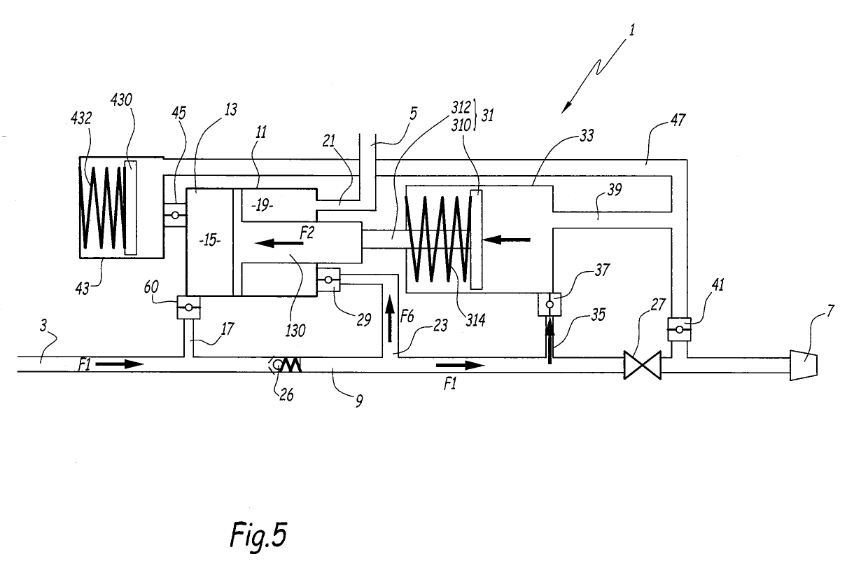

The system 1 can also be used in another configuration shown in FIG. 5, and in which the valves 29, 37 and 45 are opened simultaneously, such that the water flowing in the main pipe 9 fills the downstream part 19 of the main chamber 11 while passing through the pipe 23. This makes it possible to clean the downstream part 19, for example in the case where a different chemical product must be used. The chemical product reservoir 100 is disconnected beforehand from the inlet port 5, which is closed off by means that are not shown. The filling of the chamber 33 allows the movement of the piston 13 toward the upstream part 15 along arrow F2, which causes water to be suctioned in the downstream part 19 of the main chamber 11, via the pipe 23 along arrow F6.

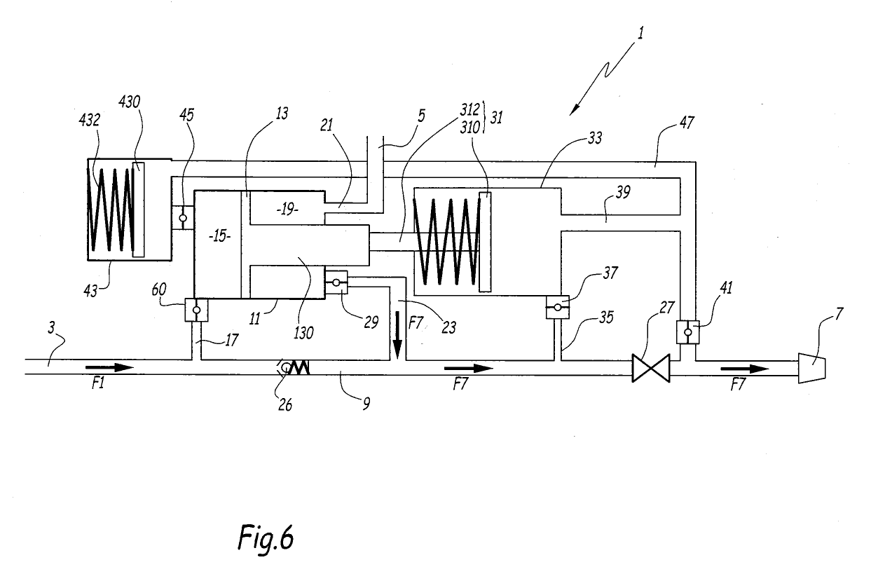

When the filling of the downstream part 19 with water is complete, to empty the upstream part 19, the valve 37 is closed, the valve 41 is open and the control device 60 is configured to allow water to enter the upstream part 15 of the chamber 11, as shown in FIG. 6. The jacks 31 and 430 are therefore pushed back by the springs 314 and 432 toward their withdrawn position. The piston 13 is pushed back toward the downstream part 19 by the water entering the upstream part 15, which makes it possible to drive the water contained in the downstream part 19 toward the main pipe 9 along arrows F7.

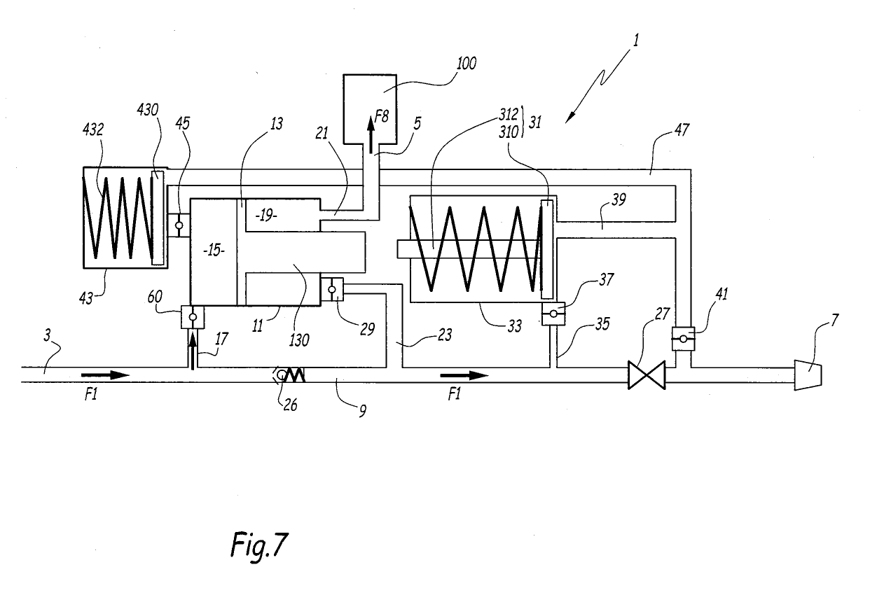

The system 1 may also be controlled such that chemical product remaining in the downstream part 19 can be transferred again into the reservoir 100. To that end, as shown in FIG. 7, the valve 29 is closed and the device 60 is controlled so as to allow the water to pass toward the upstream part 15. Thus, the piston 13 is pushed toward the downstream part 19, which results in expelling the chemical product contained in the downstream part 19 toward the pipe 21, then into the reservoir 100 along arrow F8.

The device 60 and the valves 29, 37, 41 and 45 can be controlled in a centralized manner by the user to activate the various operating modes of the system 1, for example by an electric circuit controlled from a control member.

A third embodiment of the invention is shown in FIGS. 8 and 9. In this embodiment, the system 1 does not comprise a jack 31 or an auxiliary chamber 43, but comprises a cleaning circuit 50 connected to the main pipe 9 upstream from the pipe 17, and connected to the downstream part 19 of the chamber 11. The passage of water toward the cleaning circuit 50 is controlled by a valve 52.

In this embodiment, the system 1 also comprises a valve 54 situated on the main pipe 9 upstream from the pipe 17, and which makes it possible to block the passage of water toward the downstream part of the main pipe 9.

In this embodiment, the system 1 operates as follows. To clean the downstream part 19 of the main chamber 11 with water, the valve 52 is open and the valve 54 is closed. The valve 29 is also closed. The water is therefore steered, via the cleaning circuit 50 along arrow F9, toward the downstream part 19 of the chamber 11, which results in pushing the piston 13 back toward the upstream part 15 along arrow F2.

Next, when the downstream part 19 is completely filled with water, the valve 52 is closed while the valves 54 and 29 are open. The water therefore enters the upstream part 15 of the chamber 11 and pushes the piston 13 back toward the downstream part 19, which results in driving the water contained in the downstream part 19 toward the main pipe 9. The cleaning of the downstream part 19 is therefore complete.

The control device 60 according to the invention is shown in detail in FIGS. 10 to 14. The control device 60 comprises a hollow body 62 including an inlet port 620 and an outlet port 622 between which the water is able to flow, from an upstream side toward the downstream side of the device 60. The hollow body 62 is divided into two parts 62a and 62b with a semi-cylindrical shape fastened to one another by screws 624.

According to the invention, the device 60 comprises at least one adjustment element 64 that is rotatable in the hollow body 62 around a central axis X60 of the device. In the illustrated example, the device 60 comprises three movable adjustment elements 64a, 64b and 64c, allowing very precise adjustment of the water flow passing in the control device 60. Each adjustment element 64 comprises several rotating discs 640 each pierced with several orifices 642 having different diameters, preferably increasing. The orifices 642 are distributed over an angular portion of the disc 140 and allow the passage of water in holes with different sizes in order to vary the flow rate of the water passing in the device 60. In the illustrated example, each disc 640 includes four orifices 642. As an example, the diameters of the orifices 642 can be comprised between 0.25 mm and 0.8 mm.

In the illustrated example, each adjustment element 64 comprises three discs 640 secured to one another in rotation around the axis X60. Alternatively, each adjustment element 64 may comprise a different number of discs 640. Three discs 640 are shown in FIGS. 11 to 13 with references 640a, 640b and 640c.

The control device 60 comprises stationary intermediate discs 66 relative to the adjustment elements 64 and inserted between the rotating discs 640. The device 60 comprises as many intermediate discs 66 as rotating discs 640. In the illustrated example, the device 60 therefore comprises three intermediate discs 66a, 66b and 66c. The disc 66a is inserted between the rotating discs 640a and 640b, the intermediate disc 66b is inserted between the discs 640b and 640c, and the intermediate disc 66c is placed downstream from the rotating disc 640c.

Each intermediate disc 66 is pierced with two orifices 660 suitable for being placed across from one of the orifices 642 of the rotating discs 640. The adjustment elements 64 are suitable for being rotated around the axis X60 so as to place one of the orifices 642 across from one of the orifices 660. By choosing one of the orifices 642, a user chooses the water flow he wishes to have pass into the device 60.

The presence of several rotating discs 640 and intermediate discs 66 makes it possible to create additional pressure drops and therefore to reduce the liquid flow passing in the device 60, which makes it possible to obtain very fine metering for example suitable for spraying phytosanitary products.

In order to ensure the rotational solidarity of the rotating discs 640, the intermediate discs 66 each comprise, at their center, a hole 662 through which complementary protruding forms 644 of the rotating discs 640 extend. In the illustrated example, the complementary shapes 644 are pins extending along the axis X60 and positioned diametrically opposite relative to the axis X60. Two diametrically opposite shapes 644 of one of the discs 640 cooperate with two diametrically opposite shapes 644 of another disc 640 so as to secure these two discs 640 in rotation.

The intermediate discs 66 are mounted stationary in a tube 68, which in turn is mounted stationary in the hollow body 62. The rotating discs 640 are mounted rotatably in the tube 68. Each intermediate disc 66 comprises two pins 664 each suitable for being inserted in two slots 680 provided on an inner surface of the tube 68. The tube 68 comprises an outer rib 682 suitable for being inserted in a corresponding slot, not shown, of an inner surface of the hollow body 62 in order to ensure the rotational locking of the tube 68 in the hollow body 62.

Each adjustment element 64 comprises a dial 646 secured in rotation with the rotating discs 640 and suitable for being manipulated by a user to adjust the position of the adjustment element 64. Each dial 646 is provided with positioning reference marks suitable for being viewed through an opening 626 of the hollow body 62.

The dials 646 include openings 646a through which the water is steered toward the rotating discs 640 and the intermediate discs 66.

The control device 60 comprises, in the illustrated example, three adjustment elements 64a, 64b and 64c able to be adjusted independently and each mounted in a respective tube 68a, 68b and 68c in which the intermediate discs 66 are also mounted. Each adjustment element 64 forms, with its intermediate discs 66 and its tube 68, a module able to be assembled separately and mounted in the hollow body 62, as shown in FIG. 10.

The adjustment elements 64 are placed behind one another along the axis X60, such that the water successively passes in nine orifices 642 and nine orifices 660.

According to one embodiment that is not shown, the device 60 may comprise only one adjustment element 64, or a number of adjustment elements 64 different from three.

In order to generate greater pressure drops and therefore obtain the lowest flows and a greater adjustment precision, the respective orifices 642 of two adjacent rotating discs 640 are angularly offset relative to the central axis X60. This is shown more specifically in FIG. 11. The orifices 642 of the rotating disc 640a extend diametrically opposite relative to the axis X60 with respect to the orifices 642 of the rotating disc 640b. This is also the case between the rotating discs 640b and 640c. In this way, as shown in FIG. 13, water traversing an adjustment element 64 of the device 60 must pass in baffles formed by the orifices 642, as shown by arrows F10. Preferably, the angular offset of the orifices 642 of two adjacent rotating discs 640 is 180°, which means, as is the case in the illustrated example, that the orifices 642 are diametrically opposite.

The presence of two orifices 660 on the intermediate discs 66 makes it possible, in combination with the four orifices 642 of the rotating discs 640, to have eight positions for the adjustment elements 64. This makes it possible to create additional baffled journeys for the water flow by positioning the adjustment elements 64a, 64b and 64c such that the water passing from one adjustment element 64 to the other followed a baffled journey. For example, if we consider that the adjustment element 64 of FIG. 13 is the adjustment element 64a, it is possible to position the adjacent adjustment element 64b so that the orifice 642 of the rotating disc 640c of the adjustment element 64a is diametrically opposite the orifice 642 of the rotating disc 640a of the adjustment element 64b.

According to an embodiment that is not shown, the intermediate discs 66 may comprise only one orifice 660. If the rotating discs 640 comprise four orifices 642 having increasing diameters, the adjustment elements 64 may assume five positions, one of which places the orifice 660 across from an unpierced part of a disc 640, making it possible to prevent water from flowing in the device 60. In such a case, the device 60 may act as a valve. In the case where each intermediate disc 66 comprises only one orifice 660, the respective orifices 660 of two adjacent intermediate discs 66 are angularly offset relative to the central axis X66, preferably by an angle of 180°, which makes it possible to establish a baffled trajectory for the water traversing the device 60.

According to an embodiment of the invention that is not shown, the control device 60 can also be integrated into different systems from the mixing system 1, i.e., any other system requiring precise control of the flow rate of any liquid whatsoever.

The device 60 can be adapted to control the flow of liquids other than water based on the chosen application.

The features of the embodiments and alternatives described above may be combined to form new embodiments of the invention.

1. A device for controlling a flow of a liquid in a pipe, comprising a hollow body including an inlet port and an outlet port between which a liquid is able to flow, wherein it includes at least one adjustment element rotatable in the hollow body wherein the adjustment element comprises several rotating discs secured in rotation with one another and each pierced with several orifices having different diameters, wherein the device comprises intermediate discs that are stationary relative to the adjustment element and inserted between the rotating discs, the intermediate discs being pierced with at least one orifice, and wherein the adjustment element is suitable for being moved rotatably so as to place one of the orifices of the rotating discs across from the orifice of the intermediate discs.

2. The control device according to claim 1, wherein the respective orifices of two adjacent intermediate discs and the respective orifices of two adjacent rotating discs are angularly offset relative to a central axis of the device, preferably by an angle of 180°.

3. The control device according to claim 2, wherein each intermediate disc comprises two orifices that are diametrically opposite relative to a central axis of the device.

4. The control device according to claim 1, wherein the adjustment element comprises a dial, suitable for being manipulated by a user to adjust the position of the adjustment element, and provided with positioning reference marks suitable for being viewed through an opening of the hollow body.

5. The control device according to claim 1, wherein the intermediate discs are mounted stationary in a tube mounted stationary in the hollow body, and wherein the rotating discs are mounted rotatably in the tube.

6. The control device according to claim 1, wherein the adjustment element comprises three rotating discs.

7. The control device according to preceding claim 1, wherein it comprises three adjustment elements able to be adjusted independently.

8. The control device according to claim 1, wherein each rotating disc comprises four orifices having increasing diameters.

9. The control device according to claim 1, wherein the rotating discs are secured in rotation with one another by complementary protruding shapes that extend through holes arranged in the intermediate discs.

10. A system for mixing a chemical product with water, wherein it comprises a control device according to claim 1, suitable for controlling the quantity of water mixed with the chemical product
